(19) United States
(12) Patent Application Publication
(10) Pub. No.: US 2008/0049613 A1
(43) Pub. Date: Feb. 28, 2008

(54) METHOD AND SYSTEM FOR PROVIDING A QUALITY OF SERVICE CHANGE WARNING AT A USER EQUIPMENT

(75) Inventor: Steven J. Nowlan, South Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/467,018

(22) Filed: Aug. 24, 2006

(51) Int. Cl. H04L 12/26

(52) U.S. Cl. 370/230

(57) ABSTRACT

A method and system for providing a Quality of Service (QoS) change warning at a user equipment (UE) is disclosed. The method includes predicting (304) a change in radio access resources that will provide an associated new QoS that is significantly different than a current QoS being provided by the radio access resources. Further, the method includes presenting (306) a user alert at the UE. The alert is presented to the UE when it is determined that the associated new QoS would negatively impact a current service present on the user equipment in a significant manner.

### FIELD OF THE INVENTION

The present invention relates in general to user equipments, and more specifically, to a method and system for providing a quality of service (QoS) change warning at a user equipment (UE).

### BACKGROUND

Nowadays, various services are provided at user equipments (UEs) in a communication network. Some examples of the services include, an Internet telephony service, a live news service, a stock tracking services, a voice call service, a Short Message Service (SMS), a Multimedia Message Service (MMS), a streaming video service and a streaming audio service. Examples of the communication network include, but are not limited to, a Global System of Mobile (GSM) communications network, a General Packet Radio Service (GPRS) network, a code division multiple access (CDMA) network, a Wideband Code Division Multiple Access (W-CDMA) network, and a universal mobile telephone service (UMTS) network. Some services, such as a video streaming service and an audio streaming service, can be affected by Quality of Services (QoS) provided by the communication network at a UE. The QoS at the UE can depend on signal power, data delay, data transmission rates, bit error rate, a throughput, and a bandwidth. Examples of a UE include a mobile phone, a personal digital assistant (PDA), a laptop, a pager, and so forth. The QoS provided at a UE can degrade for example, when the UE switches from one communication network to another communication network or from one channel to another channel. The degradation of the QoS can severely impact performance of certain services such as live video services, stock tracking services, and even voice call services. For example, in a worst case, a severe degradation in the QoS can even render a current service non-functional.

There exists a system to manage the bandwidth and the QoS in Internet Protocol (IP) network. A user of a UE can select a desired QoS to be provided at the UE. However, the system is unable to maintain QoS when the user moves out of the coverage of a home network. Further, the system is not applicable for networks other than IP networks.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate the embodiments and explain various principles and advantages, in accordance with the present invention.

FIG. 1 is a block diagram illustrating a geographical region, in accordance with various embodiments of the present invention;

FIG. 2 is block diagram illustrating a user equipment, in accordance with some embodiments of the present invention;

FIG. 3 is a flow diagram illustrating a method for providing a Quality of Service (QoS) change warning at a user equipment (UE), in accordance with some embodiments of the present invention; and

FIG. 4 is a flow diagram illustrating a method for providing a QoS change warning at a UE, in accordance with various embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail the particular method and system for providing a Quality of Service (QoS) change warning at a user equipment (UE) in accordance with the present invention, it should be observed that the present invention resides primarily in combinations of method steps and system components related to provide a QoS change warning at a UE. Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element. The term “another”, as used herein, is defined as at least a second or more. The term “including” as used herein, is defined as comprising.

In an embodiment, a method for providing a Quality of Service (QoS) change warning at a user equipment (UE) is provided. The method includes predicting a change in radio access resources that can provide an associated new QoS. The new QoS is significantly different from a current QoS that is provided by the radio access resources. By significantly different, here and elsewhere in this document we will mean that the difference is detectable by a human user using at least one of their senses. There is a very large body of psychophysical literature which defines the amount of change in a physical characteristic which is detectable by a human, these are usually referred to as “just noticeable differences” and have been defined for example for the auditory space for pitch differences, loudness differences, etc. for the visual space for resolution differences, contrast differences, intensity differences, flicker rate differences for video etc. The method also includes presenting an alert when it is determined that the associated new QoS would negatively impact a current service present on the UE in a significant manner.

In an embodiment, a UE operating at a QoS is provided. The UE includes a predictor unit that is capable of predicting the change in radio access resources that will provide an associated new QoS. The associated new QoS is significantly different from a current QoS provided by the radio access resources. Further, the UE includes a processor capable of determining whether the associated new QoS would negatively impact the current service on the UE in a significant manner. The UE also includes an indication mechanism. The indication mechanism is capable of presenting an alert when a determination is made that the associated new QoS would negatively impact the current service on the UE in a significant manner.

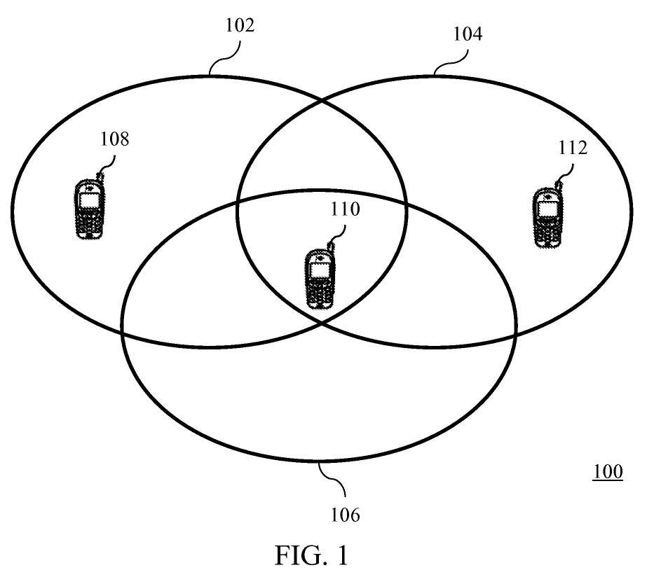

Referring to FIG. 1, a diagram illustrates a geographical region 100, in accordance with various embodiments of the present invention. The geographical region 100 can be served by one or more communication networks. Examples of a communication networks include, but are not limited to, a global system of mobile communications (GSM) network, a personal communication system (PCS) network, a general packet radio service (GPRS) network, a code division multiple access (CDMA) network, a universal mobile telephone service (UMTS) network, a wireless metropolitan area network (WMAN), a wireless local area network (WLAN), a wireless personal area network (WPAN), and an advanced mobile phone system (AMPS) network. For the purpose of this description, the geographical region 100 is shown to be covered by a communication network 102, a communication network 104, and a communication network 106. Further, one or more user equipments (UEs) can be present in the geographical region 100. A UE can be within the coverage of one or more communication networks depending on its location in the geographical region 100. For the purpose of this description, a UE 108 is shown to be within the coverage of the communication network 102, a UE 112 is shown to be within the coverage of the communication network 104, and the UE 110 is shown to be present within the coverage of the communication networks 102, 104, and 106. Examples of a UE include, but are not limited to, a mobile phone, a personal digital assistant (PDA), a laptops and a handheld wireless device.

Each network of the one or more communication networks 102, 104, and 106 can provide a specific Quality of Service (QoS). A QoS is a measure of quality of performance offered by a communication network. Typically, the QoS is measured in terms of various parameters, which are referred to as QoS measures such as channel parameters, service characteristics, and preference parameters. Typically, a QoS is measured by a Radio Access Technology Resource Controller (RAT-RC). The RAT-RC is a software that can be present on a UE. The RAT-RC can continuously monitor the radio access resources and measure their performances, capacities, and abilities to support various services.

Channel parameters include signal strength, a data delay, a data transmission rate, a bit error rate, throughput, bandwidth, and packet loss. The QoS of different communication networks can differ significantly because the communication networks can operate on different frequencies and utilize different technologies. For example, UMTS network can offer a higher bit rate and a higher capacity than those offered by GSM network. A service characteristic accounts for the services which may be very sensitive to packet loss, but not care about bit error rates, and also accounts for those services, which may be insensitive to errors but sensitive to delays. A preference parameter can be defined by a service provider, an operator, and an end user. The preference parameters can also represent policies. For example, the preference parameters can represent a policy to manage services in a manner to minimize current drain from a battery of the UE and prolong the battery life. This may impact the way a channel is operated, the choice of error correction and the retransmit rates, and in this fashion, the preference parameters impact the QoS. The QoS measures are in general a combination of channel parameters, service parameters, and preference parameters. In the description, the QoS change is attributed to switching among different communication networks but it will understood to a person ordinarily skilled in the art that the QoS change can occur within a communication network and this invention will be equally applicable in such a case as well. For an embodiment of the present invention, a communication network can have one or more cell sites. The one or more cell sites in the communication network can overlap with each other. Traversing from one cell site to another cell site within the communication network can impact associated QoS.

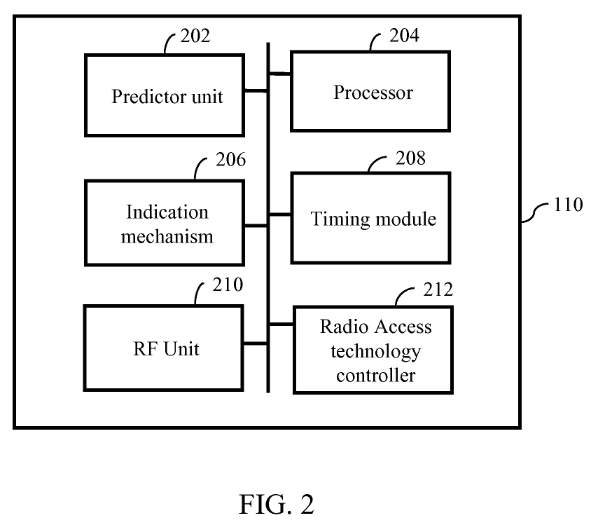

Referring to FIG. 2, a block diagram illustrates the UE 110, in accordance with some embodiments of the present invention. The UE 110 includes a predictor unit 202, a processor 204, an indication mechanism 206, a timing module 208, a Radio Frequency (RF) unit 210, and a Radio Access Technology Resource Controller (RAT-RC) 212. The predictor unit 202 is capable of predicting a change in a radio access resource that will provide an associated new QoS. A radio access resource can be a wireless transport that can support communication and various services among one or more UEs. A typical example of a radio access resource can be a set of operating frequencies. The associated new QoS is significantly different from a current QoS being provided by the radio access resource. Consider a case in which each communication network offers a different QoS. If a UE switches from one communication network to another communication network, a new QoS is provided at the UE 110 instead of the current QoS. The new QoS can be significantly different from the current QoS. The RF unit 210 can convert the audio and video signals to RF-modulated signals. The conversion of the audio and video signals to RF-modulated signals is a preliminary step in transmitting signals. The conversion enables the signals to be transmitted over long distances.

The change in the radio access resource, and corresponding change in the QoS, can impact various services that are utilized at a ULE. Examples of a service include, but is not limited to, a live news service, a stock tracking service and even a voice call service, a streaming audio service, a steaming video service, a streaming multimedia based service, and an internet telephony (IP) service. The QoS can be measured by the Radio Access Technology Resource Controller (RAT-RC) 212. The RAT-RC 212 can be a software application present on the UE 110. The RAT-RC 212 can continuously monitor the radio access resources and measure their performances, capacities, and abilities to support various services.

The processor 204 can determine whether the associated new QoS would negatively impact a current service on the UE 110 in a significant manner. For example, a live news service feed is being received at a UE, and the feed sends both headlines and images to be displayed simultaneously. A change in QoS may render the images to be encoded at a lower bit rate and can produce lower quality images. If the change in encoding rate is large enough for the drop in image quality to be visible, it indicates a significant QoS change. The UE can traverses from a communication network, which offers a higher QoS, i.e., a higher data transmission rate, to another communication network, which offers a lower QoS, a lower data transmission rate. The lower QoS can result in a discontinuity in the live news service. For an embodiment, the determination can be based on the one or more QoS measures of the current QoS and the associated new QoS and service specific significance for a QoS change. Further, the determination can also be based on a set-up time and a stabilization time. A set-up time is the time required to reflect a change in the radio access resource at a UE. Typical values of a set-up time can range from 10 seconds to 60 seconds. A stabilization time is the time taken by a UE to reach a steady state after a radio access resource is changed. Typical values of a stabilization time can range zero to five seconds. For an embodiment, the timing module 208 can determine the set-up time and the stabilization time of the new associated QoS.

For an embodiment, the configuration of the radio access resource having the associated new QoS can be selected based on factors such as QoS measures of the current QoS, corresponding projected QoS measures of the new QoS, and limit values for the one or more QoS measures and the new associated QoS measures. A limit value can be established for a service that is determined to be most sensitive to a particular QoS measure of the one or more QoS measures. For example, the performance of a video conferencing service can be more affected by a change in latency rather than a change in bandwidth. An increase in latency makes it hard to carry out a fluent conversation, since there can be an unexpectedly long delay between a question and a response. So, even though satellite channels may have a large bandwidth, they are not well suited for two way communication. On the other hand, a one way communication service, such as a television broadcast, can tolerate considerable latencies, but is much more sensitive to bandwidth. For an embodiment, the selection of the configuration of the new radio access resources can be dependent on determination of the set-up time of the new associated QoS and the stabilization time of the new associated QoS.

When it is determined by the processor 204 that the associated new QoS would negatively impact the current service on the UE 110 in a significant manner, the indication mechanism 206 can present an alert at the UE 110. Examples of the alert can be an audio message, a video message, a beep, a light indication, a text message, a vibration indication, and a graphical display. For an embodiment, the alert can contain information that at least one service can be significantly impacted within a short duration of time. For example, an alert can indicate that the voice call service will be disrupted shortly. An alert status can also be presented by the indication mechanism 206. The alert status can contain additional information. For an embodiment, the alert status can provide additional information such as QoS details of the impacted service. For example, an alert status can indicate a data transmission rate and a bit rate of the voice call service that will be disrupted shortly. For another embodiment, the indication mechanism 206 can also present an update even when the associated new QoS would negatively impact an inactive service on the UE. In such a scenario, a graphical indication can be presented by the indication mechanism 206 to inform the user of all the inactive service present on the UE 110.

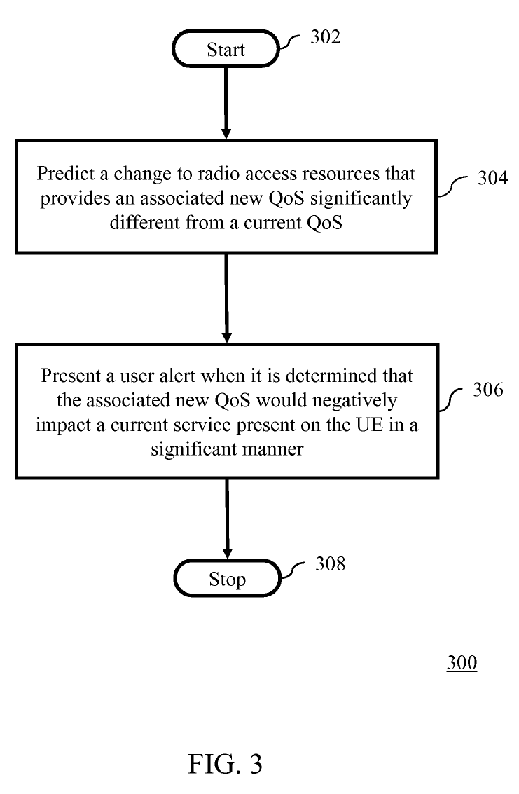

Referring to FIG. 3, a flow diagram 300 illustrates a method for providing a QoS change warning at the UE 110, in accordance with some embodiments of the present invention. The method starts at step 302. At step 304, a change in radio access resources is predicted. The change in radio access resources can result in an associated new QoS that is significantly different from a current QoS that is provided by the radio access resources. For an embodiment, the predictor unit 202 predicts the change in radio access resources. At step 306, an alert is presented to at the UE 110 when it is determined that the associated new QoS would negatively impact a current service present at the UE 110 in a significant manner. For an embodiment, the alert is presented by the indication mechanism 206.

Examples of an alert can be an audio message, a video message, a beep, a light indication, a text message, a vibration indication, a graphical display, and so forth. For an embodiment, the alert is based on a time interval between a prediction of a negative impact on the current service and an actual negative impact on the current service. For an embodiment, the alert can indicate that at least one service is likely to be significantly impacted within a short duration of time. The alert might not contain any additional information. For an embodiment, an alert status can be presented to provide additional information. For yet another embodiment, an update can also be provided even when a service that might be negatively impacted is inactive.

For an embodiment, it can be determined whether the associated new QoS would negatively impact the current service on the UE 110 in a significant manner. For another embodiment, the determination can based on the QoS measures of the current and associated new QoS. For yet another embodiment, determination can be based on the service specific significance thresholds for a QoS change, the set-up time and the stabilization time. Thereafter, the method terminates at step 308.

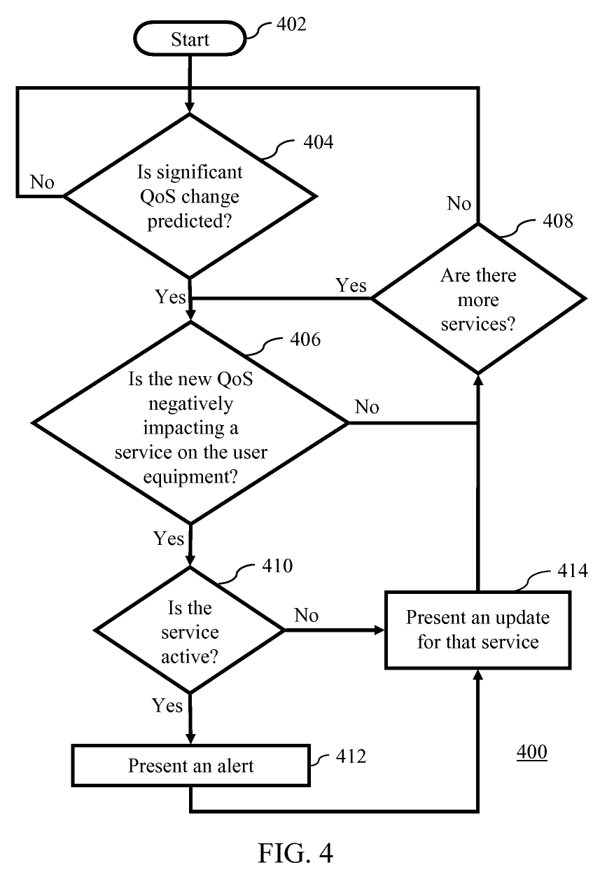

Referring to FIG. 4, a flow diagram 400 illustrates a method for providing a QoS change warning at the UE 110, in accordance with various embodiments of the present invention. The method starts at step 402. At step 404, it is determined if a significant change in QoS is predicted at the UE 110.

If it is determined at step 404 that the significant change in QoS is not predicted at the UE 110, the step 404 is repeated again. When the significant QoS is pending, it is determined at step 406 if the significant QoS change would negatively impact a service on the UE 110.

If it is determined at step 406 that the significant QoS change would not negatively impact the service on the UE 110, then it is checked if any other service is present at the UE 110 at step 408. If more services are present at the UE 110, it is again checked at step 406 if the significant QoS change would negatively impact the other service at the UE. If it is determined that there are no more services present on the UE 110, then the step 404 is followed again. When it is determined at step 406 that the significant QoS change would negatively impact the service at the UE 110, then step 410 is followed. At step 410, it is checked whether the service is active at the UE.

If it is determined that the service is active at step 410, an alert is sent to the user at step 412. The alert can inform a user of the UE 110 that at least one service at the UE 110 can be negatively impacted shortly. The alert can also include the name of such service. Thereafter, step 414 is followed. Further, if it is determined that the service is inactive at step 410, step 414 is followed. At step 414, an update is presented to the user on the UE 110. For example, an update can be used to inform the user of the UE 110 of the services that are inactive but can be negatively impacted by the change in the QoS. For example, the update can be presented to the user in form of a blinking light at the UE 110. Further, the step 408 is then again followed.

For an embodiment, based on the alert, the UE 110 can present an option to the user to choose another communication network when the current QoS is predicted to degrade. Thus, the user can select another communication network to avoid discontinuity and degradation in an active service.

Various embodiments, as described above, provide a method and system for providing a QoS change warning at a UE. The method predicts impending QoS change and determine if the QoS change will negatively impact services present at the UE. The method ensures that a user of the UE is warned by sending an alert when the impending QoS would negatively impact a service present at the UE. The method can enable the user to take some remedial actions if the user does not want an active service to get non-functional, for example, the user can switch to a communication network that can prevent degradation in QoS and hence enable smooth continuity of an impacted service.

It will be appreciated the method and system for providing a QoS change warning at a UE described herein may be comprised of one or more conventional processors and unique stored program instructions that control the one or more processors to implement some, most, or all of the functions described herein. Alternatively, the same functions could be implemented by a state machine that has no stored program instructions, in which each function or some combinations of certain portions of the functions are implemented as custom logic. A combination of the two approaches could be used. Thus, methods and means for performing these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the present invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

The terms “including” and/or “having”, as used herein, are defined as comprising. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system. It is further understood that the use of relational terms, if any, such as first and second, top and bottom, and the like are used solely to distinguish one entity or action from another entity or action without necessarily requiring or implying any actual such relationship or order between such entities or actions.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for providing a Quality of Service (QoS) Change Warning at a User Equipment (UE), the method comprising:
predicting a change in radio access resources that will provide an associated new QoS that is significantly different from a current QoS that is being provided by the radio access resources; and
presenting a alert when it is determined that the associated new QoS would negatively impact a current service present on the UE in a significant manner.

2. The method according to claim 1, wherein presenting the alert is based on a time interval between a prediction of a negative impact on the current service and an actual negative impact on the current service.

3. The method according to claim 1 further comprising determining whether the new associated new QoS would negatively impact the current service present on the UE in the significant manner.

4. The method according to claim 3, wherein the determination is made based on at least one of a set-up time of the new associated QoS and a stabilization time of the new associated QoS.

5. The method according to claim 1 further comprising selecting a new configuration of the radio access resources having the associated new QoS is based on one or more QoS measures of the current QoS, corresponding one or more projected QoS measures of the associated new QoS, and limit values of the one or more QoS measures and the one or more projected QoS measures, wherein each limit value is established for a service that is determined to be most sensitive to a particular type of QoS measure.

6. The method according to claim 5, wherein selecting the new configuration comprises determining a set-up time of the new associated QoS and a stabilization time of the new associated QoS.

7. The method according to claim 1, wherein the alert comprises substantially no information other than that at least one service is likely to be significantly impacted within a short duration of time.

8. The method according to claim 7 further comprising presenting an alert status that provides additional information.

9. The method according to claim 1, wherein determining whether the new QoS would negatively impact the current service on the UE is based on at least one of:
QoS measures of the current QoS;
QoS measures of the associated new QoS; and
service specific significance thresholds for a QoS change.

10. The method according to claim 1 further comprising presenting an update at the UE when a service is inactive.

11. A user equipment (UE) operating at a Quality of Service (QoS) comprising:
a predictor unit capable of predicting a change in radio access resources that will provide an associated new QoS that is significantly different than a current QoS being provided by the radio access resources;
a processor capable of determining whether the associated new QoS would negatively impact the current service on the UE in a significant manner; and
an indication mechanism capable of presenting an alert when a determination is made that the associated new QoS would negatively impact the current service on the ULE in a significant manner.

12. The UE according to claim 11 further comprising a timing module capable of determining a set-up time of the new associated QoS and a stabilization time of the new associated QoS.

13. The UE according to claim 12, wherein the processor determines whether the associated new QoS would negatively impact the current service based on one or more QoS measures, the set-up time, and the stabilization time.

14. The UE according to claim 11, wherein the user alert is selected from the group comprising an audio message, a video message, a text message, a vibration indication, a beep, a light indication and a graphical display.

15. The UE according to claim 11, wherein the current service is selected from the group comprising a streaming audio service, a steaming video service, a steaming multimedia based service, and an internet telephony service.

16. A computer program product for use with a computer, the computer program product comprising a computer usable medium having a computer readable program code embodied therein, for providing a Quality of Service (QoS) Change Warning at a User Equipment (UE), the computer readable program code performing:
predicting a change in radio access resources that will provide an associated new QoS that is significantly different from a current QoS being provided by the radio access resources; and
presenting a alert when it is determined that the associated new QoS would negatively impact a current service present on the UE in a significant manner.

17. The computer program product of claim 16, wherein the computer program code further performs:
determining whether the new associated new QoS would negatively impact the current service present on the UE in the significant manner.

18. The computer program product of claim 16, wherein the computer program code further performs:
presenting an alert status that provides additional information.

19. The computer program product of claim 16, wherein the computer program code further performs:
presenting a update alert when a service on the UE is not active.
